(19) United States
(12) Patent Application Publication
(10) Pub. No.: US 2007/0091828 A1
(43) Pub. Date: Apr. 26, 2007

(54) Registration, look-up, and routing with flat addresses at enormous scales

(75) Inventor: Peter Ashwood-Smith, Hull (CA)

Correspondence Address: OGILVY RENAULT LLP, 1981 MCGILL COLLEGE AVENUE, SUITE 1600, MONTREAL, QC, H3A2Y3, CA

(73) Assignee: Nortel Networks Limited, St. Laurent (CA)

(21) Appl. No.: 11/258,164

(22) Filed: Oct. 26, 2005

(51) Int. Cl. H04L 12/28

(52) U.S. Cl. 370/256

(57) ABSTRACT

A method of controlling registration, lookup and forwarding of network addresses corresponding to the flat user's node addresses, in a data network including flat user's node addresses hosted by a plurality of super-nodes. A spanning tree (ST) is preliminarily defined across the plurality of super-nodes. Thereafter, flooding of network/user's address registration messages and look-up queries a is controlled such that the messaging propagates within the mapped ST.

### CROSS-REFERENCE TO RELATED APPLICATIONS

This is the first application filed for the present invention.

### MICROFICHE APPENDIX

Not Applicable.

### TECHNICAL FIELD

The present invention relates to packet data networks, and in particular to methods for registration, look-up, and routing with flat addresses at enormous scales.

### BACKGROUND OF THE INVENTION

In modern packet data networks, nodes on the network are typically identified using a unique user's identifier or address. A common example of such an address is the well known Universal Resource Locator (URL) address, such as “ABC.com”, used in Internet Protocol (IP) networks. Other examples include Instant Messaging (IM) user names or aliases (e.g. “myalias41”); IP Phone numbers in xml (e.g. “<PHONE-NUMBER 123456789123>”); and data resources such as movies or songs (i.e. using NAPSTER etc.). As is well known in the art, in order to properly forward traffic to a desired node, the user's identifier (address) must be resolved into the corresponding network address. Thus, following the above example, in order to route an IP packet to the IM user name “myalias41”, the corresponding network (IP) address, e.g. “1.2.3.4” must be found.

In the case of so-called “flat” user's addresses (such as most URL addresses, Instant Messaging names, IP phone numbers etc), it is not possible to obtain the network address by parsing the user's address/name. In such cases, the task of finding network addresses is usually performed using a database or look-up table, in which each user's address is stored in association with its corresponding network address. In IP networks, this database is provided by a Domain Name Server (DNS), as may be seen in FIG. 1. With this arrangement, a node T can register both its IM name “myalias41”, and its network (IP) address “1.2.3.4” with the DNS. Subsequently, a node S desiring to send an IP packet to the node T first sends a look-up query containing the IM name “myalias41” to the DNS, which returns the corresponding network address “1.2.3.4”.

This approach suffers numerous limitations. For example, as the number of nodes in the network increases, so too must the size of the database. The number of registration requests received from nodes registering their network and user's address with the database, and the number of look-up queries received from nodes trying to obtain network addresses, will also increase with the size of the network. All of these factors place increasing demands on server resources, and slows the response to look-up queries.

Instant Messaging names and IP phone numbers are frequently associated with a user's Personal data Assistant (PDA) and/or mobile phone. In the case of such mobile nodes, the network address associated with any given user's address changes with time. For example, the IP address of a user's PDA will change as the user moves from one cell cite to another. With each change in IP address, the user's IM name-to-IP address and IP phone number-to-IP address associations must be registered. As will be appreciated, the resulting increase in registration requests, as nodes change network addresses, greatly exacerbates demands on server resources.

The world wide DNS system works because it is mostly static, and URL to IP address associations do not change frequently if at all. Additionally, the DNS system operates with numerous copies distributed around the world to field local queries more efficiently. However, the, increasing popularity of mobile devices (and thus rapidly changing user identifier-to-IP address associations) will inevitably exhaust the capabilities of this system.

One method of addressing these difficulties is to provide an overlay or core of “super-nodes” within the network, as may be seen in FIG. 2. Each super-node hosts a number (e.g. usually less than about 10000) of user's addresses and maintains a respective database of network and user's addresses of those sites. When a source node S wishes to obtain a network address, it sends a look-up query to its host super-node Hs. If the host super-node Hs can locate the desired network address in its own database, it returns this information to the source node S. Otherwise, it floods the look-up query to each its immediately adjacent super-nodes. Each super-node responds to the look-up query in substantially the same manner, so that the look-up query is flooded through the network of super-nodes. When the super-node H_{T} that hosts the target user's address receives the look-up query, it returns the desired network address information to the originating super-node Hs, which forwards this information to the source node S.

This approach has an advantage that it reduces the size of each database, and enables multiple databases to be searched in parallel. Both of these factors reduce demand for resources (for each individual super-node) and improve system response times. However, it also increases look-up query traffic between the super-nodes, which limits scalability of the system.

A known solution to this problem is to implement forwarding tables in each super-node to route look-up queries to the host node H_{T} that supports the target user's address. This avoids having to store anything in the super-nodes except routing information since the actual user address to network address lookup is done by the end users device directly. One method of doing this is through the use of a so-called “bloom-filter”. With this arrangement, each host node computes a hash of each user's address it supports. The hash result forms a “key”, which is then registered in the respective forwarding tables of the other super-nodes of the network. In order to find the network address associated with a desired target user's address, a source node S (or its host Hs) computes a hash of the target user's address, and inserts the hash-result into the look-up query. This enables the look-up query to be readily forwarded to the appropriate host node H_{T}. Super nodes therefore only need to know a hash value to outgoing link relationship to properly route queries to the appropriate host node H_{T}.

A variation of this technique is to design the hash function such that the hash result (“key”) is a bit-offset within an N-bit vector. This further reduces the storage required on the super nodes. As may be seen in FIG. 3, each super-node maintains a respective N-bit forwarding vector for each link to an adjacent super-node. Registration of the key with each super-node thus takes the form of merging the key with the respective forwarding vector of the link through which the registration message was received. With this arrangement, the hashed target address contained in the look-up query can be used, in conjunction with the forwarding vector of each link, to control forwarding to each link through which a host node supporting the key can be reached.

As may be appreciated, more than one user's address may hash to a common offset in the N-bit vector. This can result in a look-up query being sent to multiple host nodes, only one of which actually hosts the target user's address. For example, FIG. 4 illustrates case in which two different user's addresses, “myalias41”) and “<PHONE-NUMBER 123456789123>” hash to a bit offset of ‘3’. As a result, a look-up query launched by the source node S (seeking the network address associated with “myalias41”) will in fact be received by both the correct target host node H_{T}, and the host node H_{F} of “<PHONE-NUMBER 123456789123>”. However, in view of the enormous scalability achievable, and since only the correct target host node H_{T} will respond to look-up query, the occurrence of such “false positives” is usually considered tolerable.

A further limitation of the above-described techniques is that it is possible for a registration and/or look-up query to loop indefinitely within the network of super-nodes. While this tendency of looping is inherent to any mesh network using a distance vector style of routing, it increases with the use of bloom filtering, because the non-unique nature of the hash result naturally increases the number of links to which a look-up query can be forwarded by any given node. Typically, this issue is addressed by means of known techniques such as a time-to-live (TTL), hop count, or path vector applied to the look-up message. However, all of these techniques increase the required size of the forwarding table and packet overhead, and thus are undesirable.

Accordingly, improved techniques for registration, look-up, and routing with flat addresses at enormous scales remains highly desirable.

### SUMMARY OF THE INVENTION

Accordingly, an object of the present invention is to provide methods for registration, look-up, and routing with flat addresses at enormous scales.

Thus, an aspect of the present invention provides a method of controlling registration, lookup and forwarding of network addresses corresponding to the flat user's node addresses, in a data network including flat user's node addresses hosted by a plurality of super-nodes. A minimum spanning tree (ST) is preliminarily defined across the plurality of super-nodes. Thereafter, flooding of network/user's address registration messages, look-up queries and query response messages is controlled such that the messaging propagates within the mapped ST.

### BRIEF DESCRIPTION OF THE DRAWINGS

Further features and advantages of the present invention will become apparent from the following detailed description, taken in combination with the appended drawings, in which:

FIG. 1 schematically illustrates a data network with URL/IP address resolution using a Domain Name Server (DNS) in accordance with the prior art;

FIG. 2 schematically illustrates a data network with URL/IP address resolution using an overlay network of super-nodes, in accordance with the prior art;

FIG. 3 schematically illustrates look-up query forwarding using forwarding vector, in accordance with the prior art;

FIG. 4 schematically illustrates look-up query forwarding using bloom filtering, in accordance with the prior art;

FIG. 5 schematically illustrates a data network with URL/IP address resolution using an overlay network of super-nodes, through which a minimum spanning tree (ST) has been mapped in accordance with an aspect of the present invention;

FIG. 6 schematically illustrates look-up query forwarding in a super-node of the network of FIG. 5;

FIG. 7 schematically illustrates a data network with URL/IP address resolution using an overlay network of super-nodes, through which a pair of topologically diverse minimum spanning trees (STs) have been mapped in accordance with an aspect of the present invention;

FIG. 8 schematically illustrates look-up query forwarding in a super-node of the network of FIG. 7;.

It will be noted that throughout the appended drawings, like features are identified by like reference numerals.

### DETAILED DESCRIPTION OF THE PREFERRED EMBODIMENT

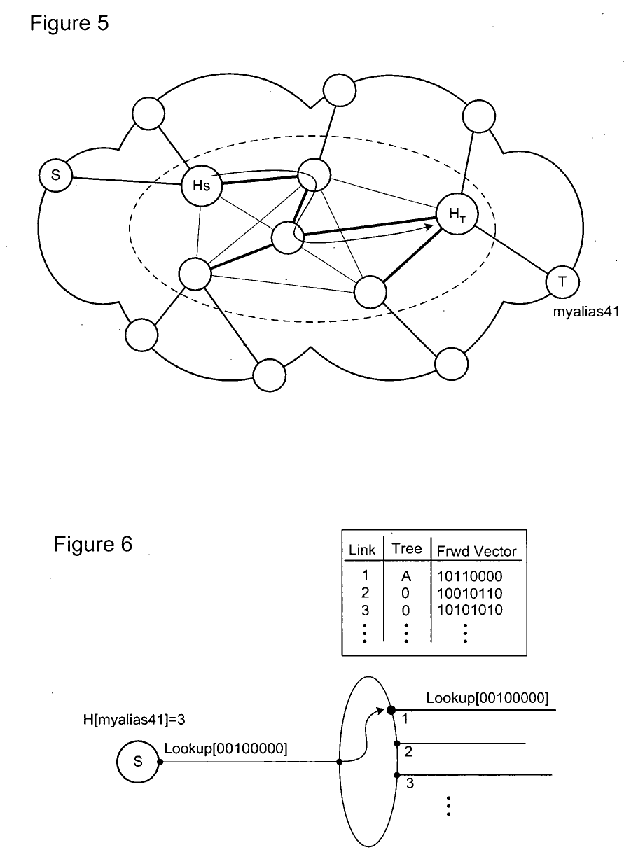

The present invention provides methods for registration, look-up, and routing with flat addresses at enormous scales. Embodiments of the invention are described below, by way of example only, with reference to FIGS. 5-8.

In general, the present invention solves the problem of looping by computing a spanning tree (ST) through the network of super-nodes. Registration of Network and user's addresses can then be performed by flooding registration messages (and/or forwarding table updates e.g. via link state advertisements) through the computed tree. Similarly, flooding of look-up queries is restricted to the computed tree, which prevents looping because an ST, by definition, does not contain loops.

As is well known in the art, there are a number of techniques for computing a spanning tree (ST) through a network of nodes. However a preferred approach is to use a link state protocol such as OSPF/IS-IS to provide each node with the full view of the super-node network topology, followed by one or more applications of Kruskal's algorithm (preferably run in parallel on every node in the super node network) to compute the set of spanning trees. Once the set has been computed, links incident to the node are then tagged as being members (or not) of the respective spanning trees. Tree diversity and the optimality of any given tree with respect to the network and other trees, while beneficial, are not essential. Furthermore, the spanning tress may, or may not include “minimum total cost spanning trees” or, equivalently “minimums spanning trees” (MSTs). Techniques are known for all of these computations, which should be evident to one versed in the art of graph theory, and thus will not be described in greater detail herein.

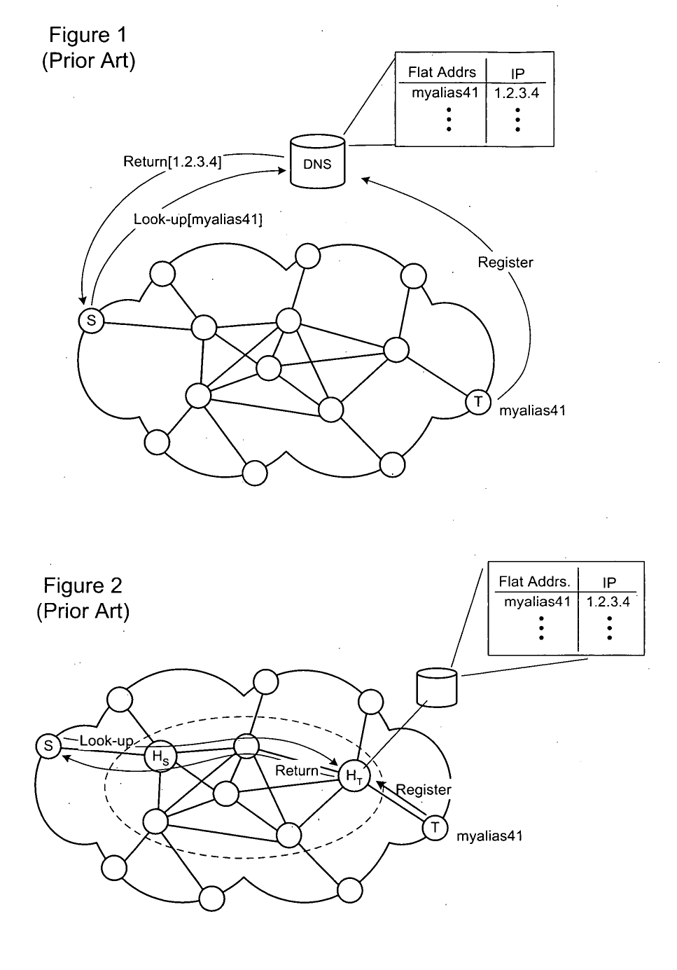

FIGS. 5 and 6 illustrate the network of FIGS. 1-4, in which an ST (indicated with bold lines) has been mapped through the super-node network. As is known in the art, an ST comprises a set of nodes connected by edges. Each ST node corresponds with a super-node of the data network node, and each edge traverses a link of the data network, between a pair of ST nodes. With this arrangement, registration messages launched by a host node H_{T} are confined to the ST, and thus cannot loop. Similarly, a look-up query traversing the super-node network is forwarded using both the forwarding vector and the ST mapping. Thus, each super-node forwards a received look-up query to each link which: is on the same ST as the edge through which the query was received; AND through which a host node supporting the key can be reached. As will be appreciated, this arrangement both eliminates the possibility of looping of look-up messages, and at the same time minimizes Look-up query traffic within the super-node network.

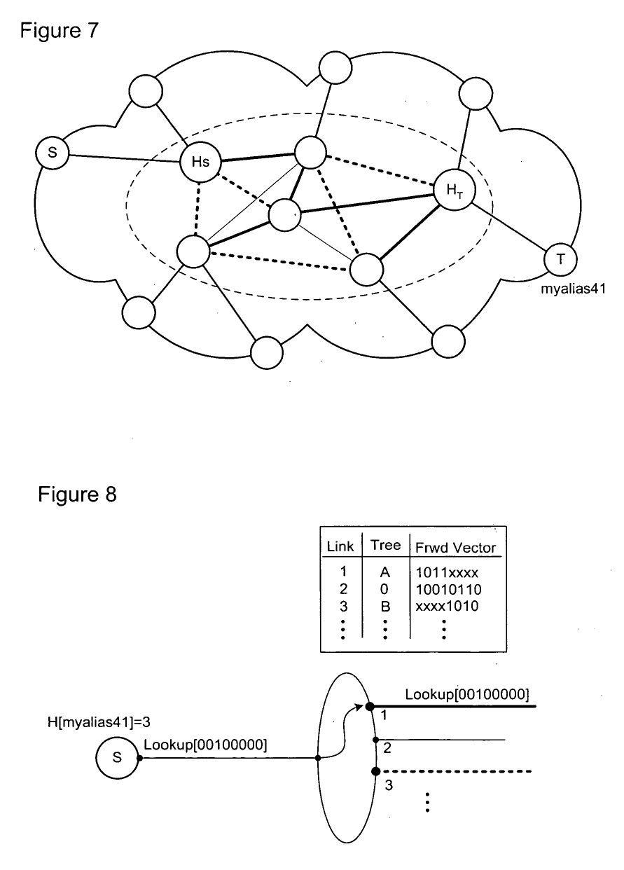

In the example of FIG. 5, a single spanning tree is mapped through the super-node network. In many cases, it will be desirable to map two or more STs within the network. FIG. 7 illustrates an example in which two STs are mapped through the network; ST-A indicated in bold solid lines, and ST-B indicated in bold dashed lines. In this example, there are no links shared by the two STs, so complete topological diversity is provided. This can be of advantage from both traffic engineering and failure recovery standpoints. If additional spanning trees were to be mapped through the super-node network of FIG. 7, complete topological diversity would not be possible. However, in each case it is preferable to maximize topological diversity between spanning trees, such that each super-node to super-node connection supports the least number of spanning tree links as possible.

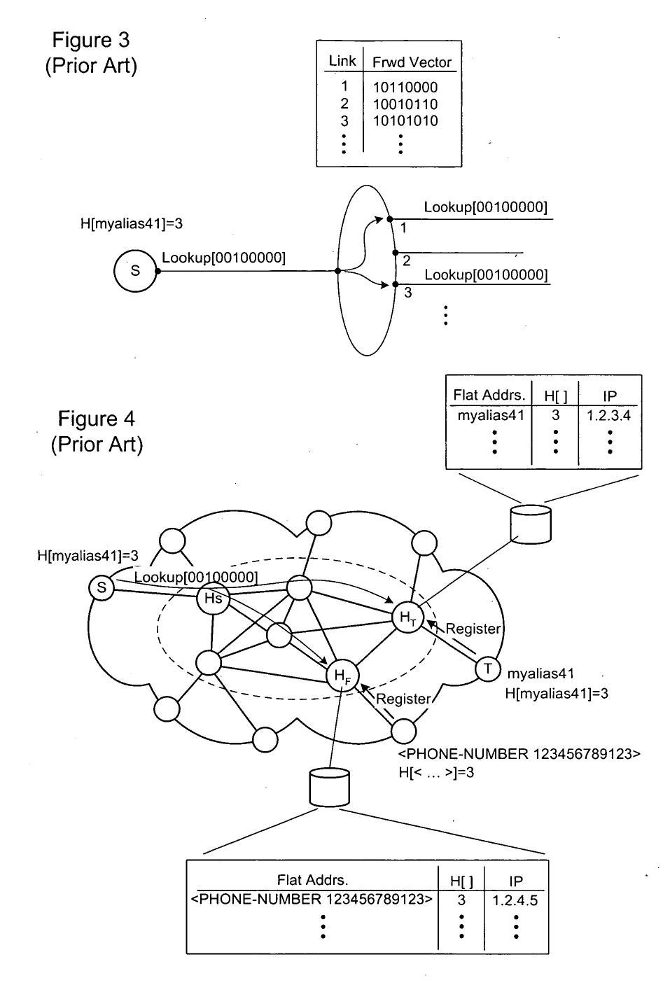

The use of multiple STs within the super-node network offers a further advantage, in that it enables the N-bit forwarding vector to be split across the various STs. For example, in FIGS. 3 and 4, an N=8 bit forwarding vector is employed. It is possible to divide this forwarding vector into two segments, each of which is assigned to a respective ST. Thus, in the example of FIGS. 7 and 8, bit offsets 0-3 are handled by ST ‘A’, and bit offsets 4-6 are handled by ST ‘B’. More generally, for a super-node network having M spanning trees, each ST will handle a respective subset of K=N/M bits of the N-bit forwarding vector. Thus, ST j (1≦j≦M) will handle bits (j−1)K . . . jK−1 of the N-bit forwarding vector. Of course other mechanisms of partitioning the bit vector are permitted and this simple linear mapping is just an example of one practical method.

With this arrangement, registration of a user's address involves steps of: hashing the user's address to a bit offset; using the bit offset to select the appropriate one of the STs; and then flooding a registration message containing the hashed address through the selected ST. Each super-node that receives the registration message uses the hashed address to update its forwarding table, before flooding the registration message through downstream edges (if any) of the ST.

Look-up queries can conveniently be treated in a similar manner. Thus, the source node S (or the super-node Hs that hosts it) can hash the target user's address to a bit offset; use the bit offset to select an appropriate one of the STs; and then flood a look-up query containing the hashed address through the selected ST. Each super-node that receives the look-up query uses the hashed address to control flooding of the look-up query through downstream edges (if any) of the ST.

As may be appreciated, this arrangement has advantages in that it splits look-up query and response traffic between the STs which, due to the topological diversity of the STs, distributes the traffic across the network. An additional advantage is that the forwarding vector of each ST is shorter (by a factor of M) than the “complete” N-bit forwarding vector. This enables the use of a longer forwarding vector, which reduces the probability of false hits, without increasing server resources dedicated to any one ST/link.

The embodiment(s) of the invention described above is(are) intended to be illustrative only. The scope of the invention is therefore intended to be limited solely by the scope of the appended claims.

We claim:

1. In a data network including flat user's addresses hosted by a plurality of interconnected super-nodes, a method of controlling registration and lookup of network addresses corresponding to the flat user's addresses, the method comprising steps of:
preliminarily defining a spanning tree (ST) across the plurality of super-nodes; and
thereafter, controlling flooding of network/user's address registration messages and look-up queries to propagate within the mapped ST.

2. A method as claimed in claim 1, wherein a plurality of spanning trees are mapped across the plurality of super-nodes.

3. A method as claimed in claim 2, wherein the step of controlling flooding of registration messages and look-up queries comprises steps of, at a source node:
hashing a target user's address to a derive a key value;
using the key value to select one of the plurality of spanning trees (STs); and
flooding the registration messages and look-up queries within the selected ST.

4. A method as claimed in claim 2, wherein the step of controlling flooding of registration messages and look-up queries comprises steps of, at a first super-node:
receiving a look-up query through an edge of one of the plurality of STs;
if the target user's address is hosted by the first super-node:
generating a query response message including the corresponding network address; and sending it directly to the network address of the source of the query.
otherwise, flooding the received look-up query through edges of same ST, other than that through which the look-up query was received.

5. A method as claimed in claim 4, wherein the step of flooding the received look-up query comprises a step of forwarding the received look-up query to only those edges of the ST through which a super-node hosting the target user's address can be reached.

6. A method as claimed in claim 5, further comprising a step of implementing a respective bloom filter in each ST.

7. A method as claimed in claim 6, wherein the bloom filter comprises a respective subset of K bits of an N-bit forwarding vector, and wherein the key value is a bit offset of the N-bit forwarding vector.

8. A method as claimed in claim 1, wherein the spanning tree is computed from a topology distributed by a link state protocol.

9. A method as claimed in claim 8, wherein the link state protocol comprises any one of: OSPF/OSPF-TE, IS-IS, IS-IS-TE, PNNI, and Rbridge.

10. A method as claimed in claim 2, wherein the spanning trees (STs) are minimum total cost (STs).

11. A method as claimed in claim 2, wherein the spanning trees (STs) are computed to be maximally topologically diverse.
